(19) United States
(12) Patent Application Publication
(10) Pub. No.: US 2026/0301486 A1
(43) Pub. Date: Oct. 1, 2026

(54) Vehicle Drive Record Management System

(71) Applicant: Nissan North America, Inc., Franklin, TN (US)

(72) Inventors: Atsushi Kasuya, Los Altos Hills, CA (US); Mark Bailey, Seattle, WA (US); Corey Heath, Scottsdale, AZ (US); Kevin Kochever, San Bruno, CA (US); Luis Lorenzo Bill Clark, San Francisco, CA (US); Erik Lee St. Gray, Tacoma, WA (US)

(21) Appl. No.: 19/093,426

(22) Filed: Mar. 28, 2025

(51) Int. Cl. G07C 5/08; G06F 16/22

(52) U.S. Cl. CPC G07C 5/0841; G06F 16/2237; G07C 5/0816

(57) ABSTRACT

A system and method for vehicle record management including integrating localized vehicle incident data with a large language model (LLM). Sensors of a vehicle record incidents of driving and parking, which are filtered for relevance and used to generate embeddings that are stored in a database. Relevant embeddings are retrieved based on a received question using retrieval-augmented generation (RAG), and a prompt for an LLM is generated based on contextual information associated with the one or more relevant embeddings. The LLM generates a response to the prompt, which is output as an answer to the question.

### TECHNICAL FIELD

This disclosure relates generally to a vehicle record management system, and more specifically, to systems and methods for integrating localized vehicle incident data with a large language model (LLM).

### BACKGROUND

Advancements in artificial intelligence (AI) and machine learning (ML) have enabled the development of sophisticated models capable of processing large volumes of data to generate meaningful insights. In particular, LLMs and retrieval-augmented generation (RAG) techniques have become increasingly valuable in various applications, including natural language processing, autonomous systems, and decision support systems.

An LLM is an advanced ML model trained on large-scale text data to understand and generate human-like language. These models leverage deep learning architectures, such as transformers, to process textual input and produce relevant responses. Examples of LLMs include GPT-4, BERT (bidirectional encoder representations from transformers), and T5 (text-to-text transfer transformer).

LLMs are commonly pretrained on extensive datasets, such as web documents, books, and conversational transcripts, to develop a broad understanding of language. They can then be fine-tuned on domain-specific data to improve performance in specialized applications. For instance, an LLM trained on automotive data can assist with driver support, fleet management, or accident analysis.

### SUMMARY

RAG is a technique that enhances language model responses by incorporating retrieved external information into the generation process. Unlike traditional LLMs, which rely solely on their pretrained knowledge, RAG-based systems dynamically fetch relevant data from an external source, such as a vector database, to ground their responses in real-time information.

A RAG pipeline may include the following steps: (1) question processing, where a system receives an input question , such as a request for information about a recorded driving incident; (2) embedding retrieval, where the system converts the question into an embedding (e.g., a numerical representation of textual data) and searches for similar embeddings stored in a database; and (3) augmented response generation, where the retrieved embeddings provide contextual information that the LLM incorporates into its response to improve accuracy and relevance.

For example, in a vehicle record management system, if a user queries, “what happened near the intersection at 3rd and Main yesterday?”, a RAG-based system would retrieve relevant driving incident data, such as sudden braking or collisions recorded in that area, before generating a response. In a situation where the user’s vehicle was at that intersection at that time, some or all of the retrieved incident data would have been recorded by sensors of the user’s vehicle. In other words, the vehicle record management system integrates localized, and even personalized, incident data with an LLM.

The integration of LLMs and RAG into vehicle monitoring systems, such as the disclosed vehicle record management system, can provide enhanced situational awareness, improved driver assistance, and more accurate post-event analysis. By leveraging real-time sensor data and historical embeddings, such systems may be able to, for example: (1) detect and record driving and parking incidents based on predefined conditions (e.g., sudden braking, collisions, or unauthorized access); (2) allow users to query past incidents using natural language, receiving AI-generated summaries grounded in stored data; and (3) improve incident investigation and insurance claims processing by retrieving precise event details. Such an approach bridges a gap between sensor-based event detection and AI-driven analytics, offering a more intelligent and interactive way to manage vehicle-related data.

Specifically, disclosed herein are aspects, features, elements, implementations, and embodiments of a method, a system, and a non-transitory computer-readable medium for integrating localized vehicle incident data with a large language model (LLM).

A first aspect of the disclosed implementations is a method that includes the steps of: recording, by sensors of a vehicle, incidents of driving and parking based on predefined triggering conditions; filtering the incidents to identify relevant incidents for storage; generating embeddings corresponding to the relevant incidents; storing the embeddings in a database; receiving a question concerning the relevant incidents; retrieving, using retrieval-augmented generation (RAG), one or more relevant embeddings based on the question; generating a prompt based on contextual information associated with the one or more relevant embeddings; generating, by a large language model (LLM), a response to the prompt; and outputting the response as an answer to the question.

A second aspect of the disclosed implementations is a system that includes one or more memories and one or more processors configured to execute instructions stored in the one or more memories to implement the steps of the method described above.

A third aspect of the disclosed implementations is a non-transitory computer-readable medium storing instructions operable to cause one or more processors to perform operations according to the steps of the method described above.

As used herein, the term “vehicles” encompasses driver-operated vehicles and semi-autonomous or autonomous vehicles (which may be referred to as self-driving vehicles) and similar terms unless stated otherwise or indicated by context.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system for integrating localized vehicle incident data with an LLM.

FIG. 5 is a diagram of an example of a system comprising a vehicle with sensors for obtaining sensor data for use by a vehicle record management system.

FIG. 6 is a flowchart of an example of a process for integrating localized vehicle incident data with an LLM.

### DETAILED DESCRIPTION

To describe some implementations in greater detail, reference is made to the following figures.

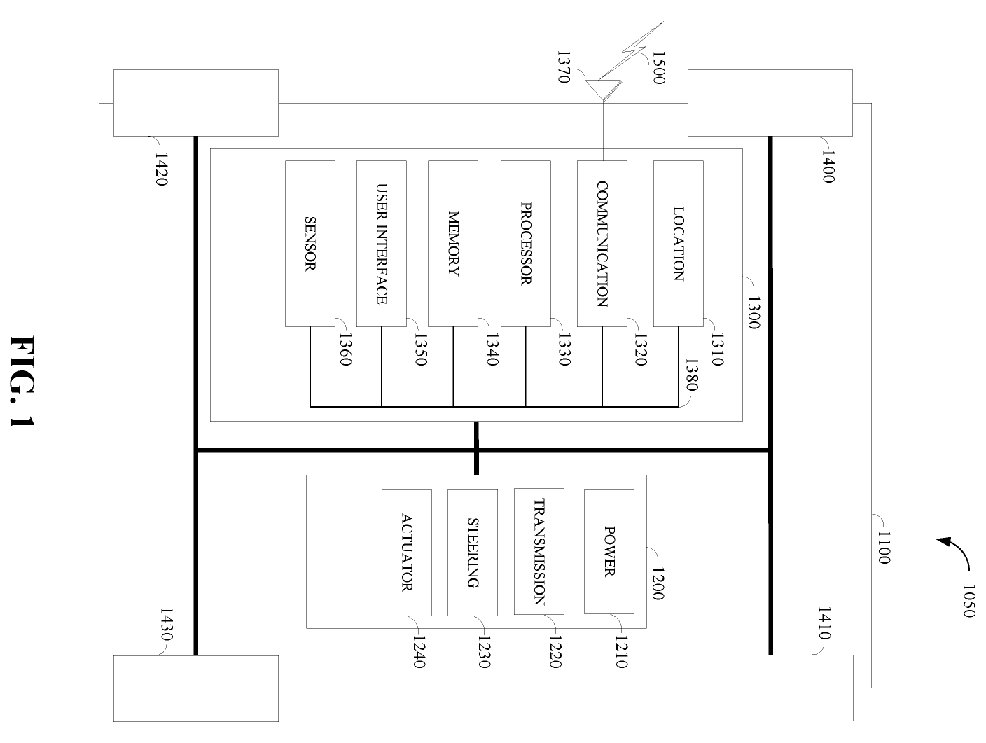

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch-based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment within or surrounding the vehicle 1050. With regard to within the vehicle 1050, e.g., the in-cabin environment, one or more sensors may detect objects within the vehicle, such as groceries, electronic devices, pets, people, in-vehicle controls, and so on. With respect to surrounding the vehicle, e.g., the external, exterior, or outside environment, one or more sensors may detect road geometry and obstacles, such as fixed obstacles, vehicles, cyclists, and pedestrians. In some embodiments, the sensor 1360 can be or include one or more still or video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

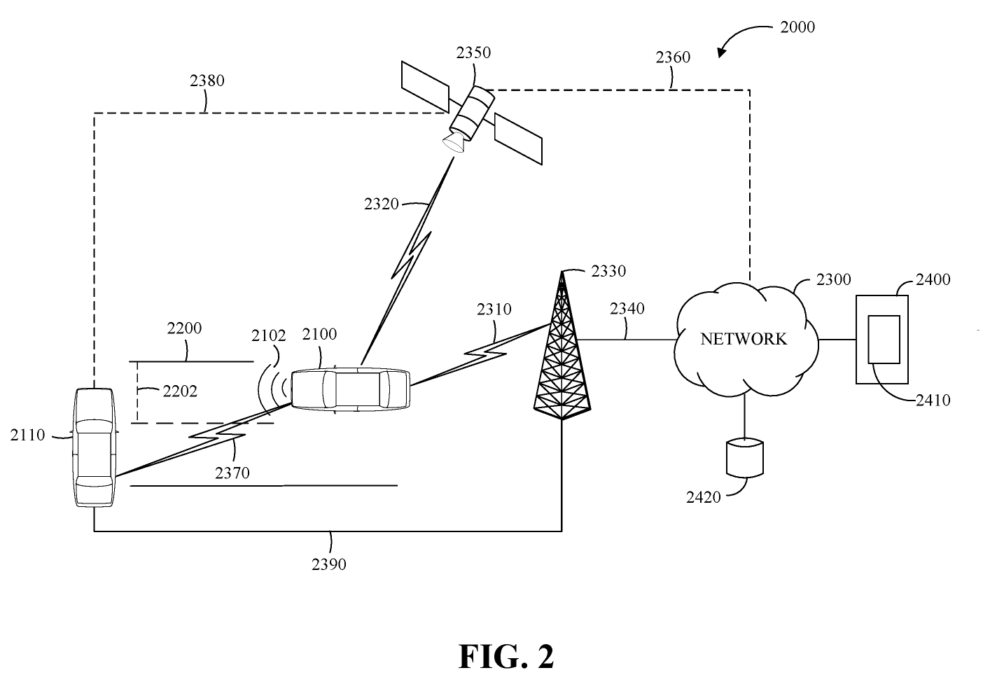

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

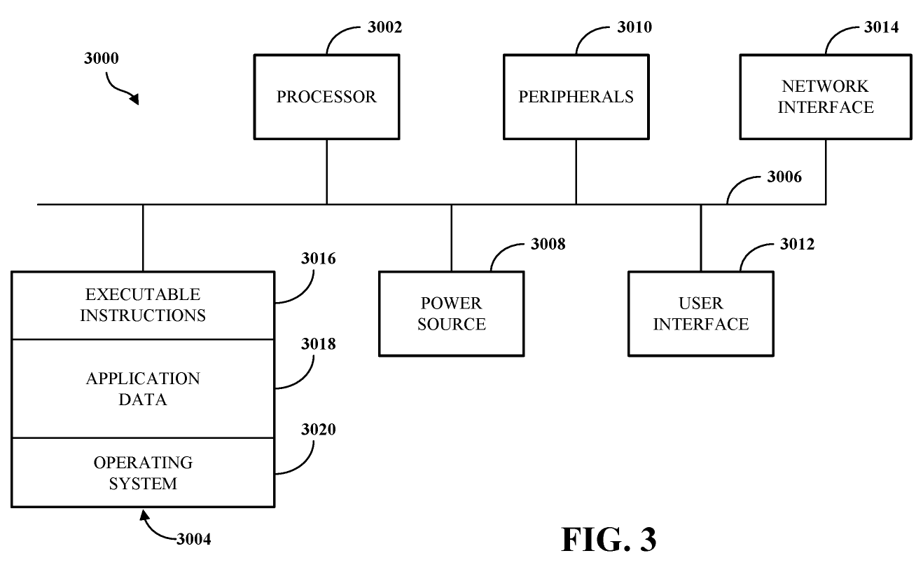

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3, which is described later herein. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 may be, for example, the controller 1300 shown in FIG. 1 or the computing apparatus 2410 shown in FIG. 2. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

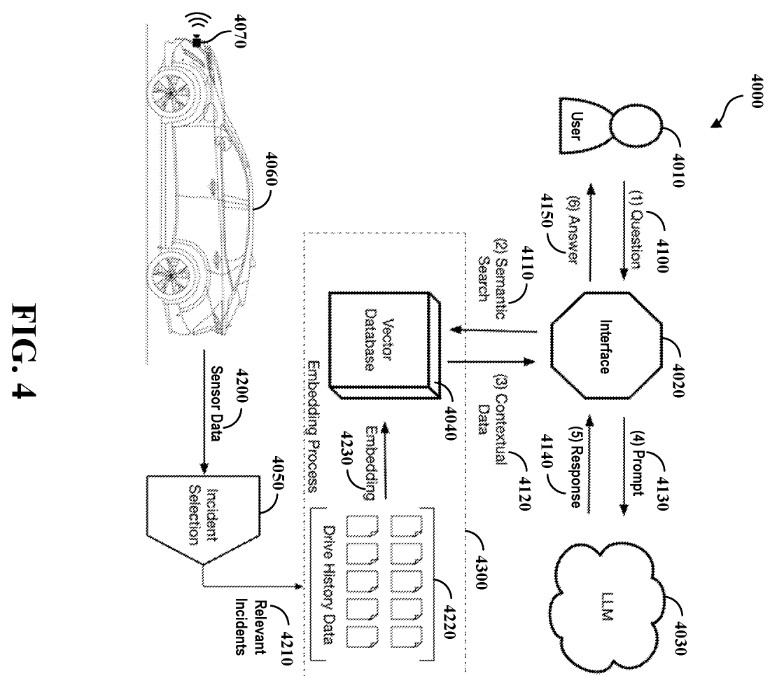

FIG. 4 is a diagram of an example of a system 4000 for integrating localized vehicle incident data with an LLM 4030. The system 4000 may comprise processing components that are internal and/or external to the vehicle 4060, which may be the vehicle 2100 of FIG. 2. Such internal processing components may comprise, for example, the controller 1300, including the location unit 1310, the electronic communication unit 1320, the processor 1330, the memory 1340, the user interface 1350, the sensor 1360, or the electronic communication interface 1370 of FIG. 1. Such external processing components may comprise, for example, the computing apparatus 2410 and or the database server 2420.

In the illustrated system 4000, a vehicle 4060 comprises one or more sensors 4070, which may comprise instances of the sensor 1360 of FIG. 1, for example, a lidar sensor; a radar sensor; a sonar sensor; an ultrasonic sensor; an infrared sensor; an optical camera; or a Global Navigation Satellite System (GNSS) sensor, that sense, detect, collect, gather, capture, record, or otherwise acquire sensor data 4200 that may be relevant to driving and/or parking incidents of the vehicle 4060.

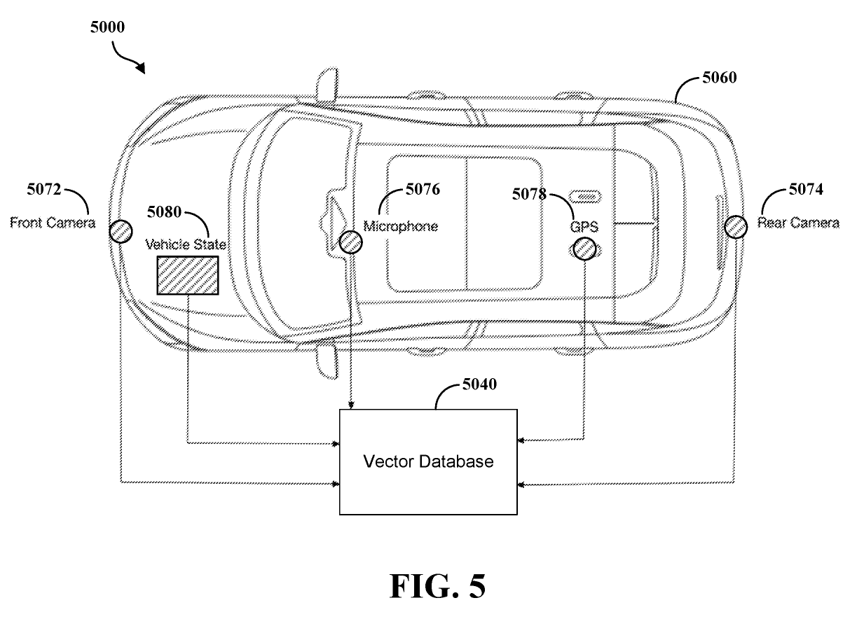

FIG. 5 is a diagram of an example of a system 5000 comprising a vehicle 5060, which may be the vehicle 4060, with sensors for obtaining sensor data for use by the disclosed vehicle record management system. The sensors of the vehicle 5060 include a front camera 5072, a rear camera 5074, a cabin microphone 5076, a GPS unit 5078 (i.e., a GNSS unit), and a vehicle state 5080, which may comprise states of battery charge, tire pressures, fuel level, oil level or age, and so on. The data collected or acquired by the sensors comprise contextual data that is transformed into embeddings and stored in a vector database, such as the database 4040, as described below.

Returning to FIG. 4, the sensor data 4200 may be considered as incidents of driving and parking. The recording of the sensor data 4200 may be based on predefined triggering conditions, such as: activation of an engine of the vehicle; activation of a predefined drive mode of the vehicle; a number of occupants of the vehicle exceeding a predefined threshold; a charge state of a battery of the vehicle dropping below a predefined threshold; the vehicle exceeding a predefined speed threshold; the vehicle exceeding a predefined acceleration or deceleration threshold; the vehicle exceeding a predefined change of direction threshold; the vehicle coming within a predefined distance of an object; the vehicle entering or exiting a predefined geofenced area; or the vehicle receiving driver input to initiate recording. Additionally, the predefined triggering conditions may comprise one or more of: detection, by one of the sensors of the vehicle, of a predefined object near the vehicle, such as a pedestrian or a trash can; or detection, by one of the sensors of the vehicle, of a predefined vehicle near the vehicle, such as a lead or follow vehicle.

The sensor data 4200 is provided to an incident selector 4050, which may also be referred to herein as a filtering module, that filters the sensor data 4200 to identify relevant incidents 4210 for storage. Filtering the sensor data 4200 to identify relevant incidents 4210 for storage may be based on at least one of: severity of the incidents; proximities of the incidents to predefined geographic locations; times of occurrence of the incidents; or presence of specific driving behaviors. The incident selector 4050 may be internal and/or external to the vehicle 4060.

A plurality of relevant incidents 4210 may be referred to herein as a drive history data 4220. The drive history data 4220 (which may describe incidents of both driving and parking) may be unstructured textual, visual, or numerical data that is not directly suitable for efficient processing by an LLM 4030. Converting or transforming relevant incidents 4210 into respective embeddings 4230 enables the system to represent the drive history data 4220 in a dense numerical format that captures semantic meaning while allowing for efficient similarity searches. Embeddings 4230 of the relevant incidents 4210 facilitate RAG-based processing by enabling rapid comparison between the embeddings 4230 and incoming user question(s) 4100, ensuring that relevant contextual information 4120 can be efficiently identified and retrieved. Without the embeddings 4230, the LLM 4030 may struggle to process the unstructured drive history data 4220 effectively, as it may lack an ability to natively interpret non-textual or high-dimensional information. The embeddings 4230 comprise multi-dimensional vector representations of the relevant incidents. Generating the embeddings 4230 may be performed by an embedding module 4300, which may be internal and/or external to the vehicle 4060. The terms contextual information and contextual data may be used interchangeably herein.

The embeddings 4230 are stored in a database 4040. The database 4040 may be a vector database. A vector database is a specialized database optimized for storing and searching embeddings. Examples include FAISS (Facebook AI Similarity Search), Pinecone, and Weaviate. A vector database enable fast and efficient retrieval of relevant incidents 4210 of the drive history data 4220, ensuring that responses 4140 of the LLM are based on highly relevant historical events of the vehicle 4060. The database 4040 may be housed within the vehicle 4060 or it may be located in one or more cloud servers, such as the database server 2420 of FIG. 2. In some implementations, the embeddings 4230 may be encrypted prior to storage.

As illustrated in the example system 4000 of FIG. 4, a user 4010 asks a question 4100 related to information concerning the drive history data 4220 of the vehicle 4060. The question 4100 may be provided to the interface 4020 in a suitable form, such as by voice or by text. The interface 4020 comprises hardware and/or software elements capable of receiving and processing the question 4100.

The interface 4020 performs a semantic search 4110 to the database 4040 based on the question 4100 to retrieve one or more relevant embeddings of the embeddings 4230. The semantic search 4110 comprises the RAG-based processing described above, where retrieving the one or more relevant embeddings may be based on at least one of: similarity scores between the question 4100 and the embeddings 4230; proximities of the embeddings 4230 to a predefined threshold; or occurrences of specific keywords or features within the embeddings 4230 that match the question. The one or more relevant embeddings are associated with contextual information 4120 of the drive history data 4220. Retrieving the one or more relevant embeddings—and the contextual information 4120 associated therewith—may be performed by a retrieval module, such as the interface 4020, which may be internal and/or external to the vehicle 4060.

A prompt 4130, for the LLM 4030, is generated based on the question and the contextual information 4120 associated with the one or more relevant embeddings. The LLM 4030 processes the prompt and generates a response 4140. The interface 4020 outputs the response 4140, or a modified form thereof, as an answer to the question 4100. The LLM 4030 may be executed by one or more cloud servers, such as the database server 2420 of FIG. 2. The LLM may be pretrained on a general corpus of text data such that it can appropriately process the question 4100. After pretraining, the LLM 4030 may be fine-tuned on generalized driving and parking incident data such it can appropriately process the contextual information 4120. In some implementations, the LLM 4030 may be fine-tuned, after pretraining, on a specialized dataset of driving and parking incidents to enhance its understanding of vehicle-related contexts. In some implementations, the LLM 4030 may be restricted of further fine-tuning by the one or more relevant embeddings or by the embeddings 4230. In this way, the LLM 4030 may remain unmodified from its original pretraining and/or fine-tuning.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

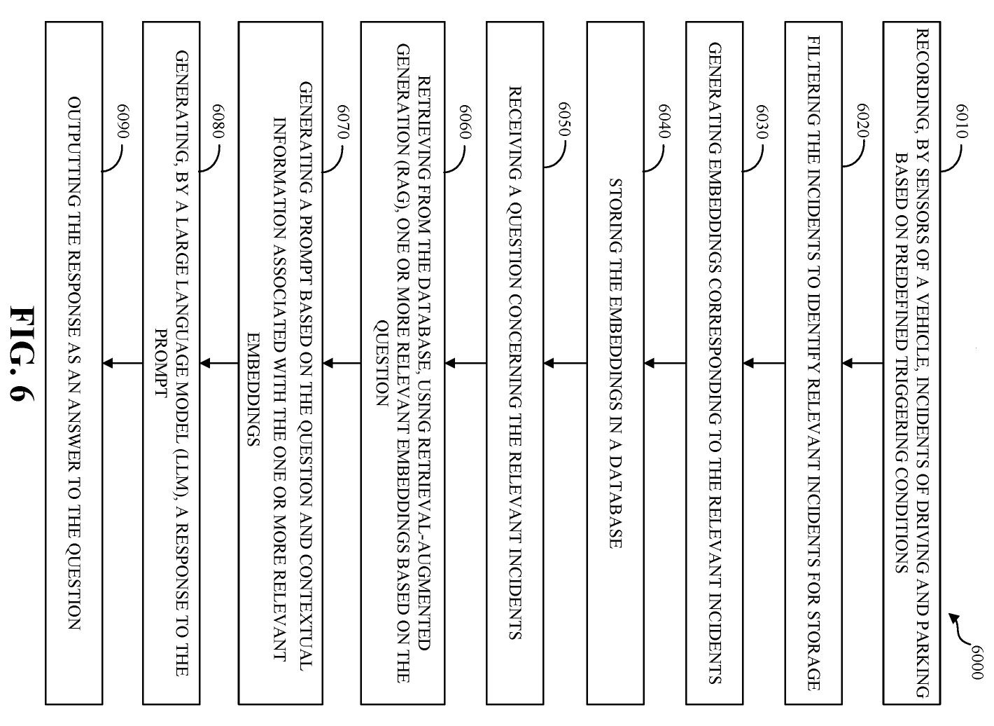

FIG. 6 is a flowchart of an example of a technique 6000 for integrating localized vehicle incident data with an LLM. This technique, or process, may be implemented by a system whose components may be internal and/or external to a vehicle, such as the controller 1300 of FIG. 1 or the computing apparatus 2410 of the data-processing center 2400 of FIG. 2.

The step 6010 comprises recording, by sensors of a vehicle, incidents of driving and parking based on predefined triggering conditions. The vehicle may be the vehicle 4060 of FIG. 4, the sensors may be the one or more sensors 4070 of FIG. 4, and the incidents may be comprised in or determined by the sensor data 4200 of FIG. 4. The predefined triggering conditions may include, for example, activation of an engine of the vehicle; activation of a predefined drive mode of the vehicle; a number of occupants of the vehicle exceeding a predefined threshold; a charge state of a battery of the vehicle dropping below a predefined threshold; the vehicle exceeding a predefined speed threshold; the vehicle exceeding a predefined acceleration or deceleration threshold; the vehicle exceeding a predefined change of direction threshold; the vehicle coming within a predefined distance of an object; the vehicle entering or exiting a predefined geofenced area; the vehicle receiving driver input to initiate recording; detection, by one of the sensors of the vehicle, of a predefined object near the vehicle; or detection, by one of the sensors of the vehicle, of a predefined vehicle near the vehicle.

The step 6020 comprises filtering the incidents to identify relevant incidents for storage. The relevant incidents may be the relevant incidents 4210 of FIG. 4. The filtering may be performed by a filtering module, such as the incident selector 4050 of FIG. 4. The filtering module may be local to the vehicle or it may be remote to the vehicle (or both). Determining relevance of incidents for storage may include determining severity of the incidents (where incidents whose severity exceeds a predefined threshold are deemed relevant); proximities of the incidents to predefined geographic locations (where incidents whose proximities exceeds a predefined threshold are deemed relevant); times of occurrence of the incidents (where incidents that occur around predefined times are deemed relevant); or presence of specific driving behaviors (where incidents that characterize specific driving behaviors are deemed relevant).

The step 6030 comprises generating embeddings corresponding to the relevant incidents. The embeddings may be the embeddings 4230 of FIG. 4. The generating of embeddings may be performed by an embedding module, such as the embedding module 4300 of FIG. 4. The embedding module may be local to the vehicle or it may be remote to the vehicle (or both).

The step 6040 comprises storing the embeddings in a database. The database may be the database 4040 of FIG. 4. The database may comprise a vector database. The database may be local to the vehicle or it may be remote to the vehicle (or both). In some implementations, the embeddings may be encrypted prior to storage, for example, to enhance privacy and/or security. In such case, retrieval of embeddings from the database comprises or is followed by a decryption process.

The step 6050 comprises receiving a question concerning the relevant incidents. The question may be the question 4100 of FIG. 4. The question may be received by an interface module, such as the interface 4020 of FIG. 4. The interface module may be local to the vehicle or it may be remote to the vehicle (or both). The question may comprise a voice command.

The step 6060 comprises retrieving from the database, using retrieval-augmented generation (RAG), one or more relevant embeddings based on the question. The retrieval may comprise a semantic search, such as the semantic search 4110 of FIG. 4. The one or more relevant embeddings may comprise or be associated with contextual information, such as the contextual information 4120 of FIG. 4. Retrieving of the one or more relevant embeddings may be performed by a retrieval module, such as the interface 4020 of FIG. 4. The interface module may be local to the vehicle or it may be remote to the vehicle (or both).

The step 6070 comprises generating a prompt based on the question and contextual information associated with the one or more relevant embeddings. The prompt may be the prompt 4130 of FIG. 4. Generating the prompt may be performed by an interface module, such as the interface 4020 of FIG. 4. The interface module may be local to the vehicle or it may be remote to the vehicle (or both).

The step 6080 comprises generating, by a large language model (LLM), a response to the prompt. The LLM may be the LLM 4030 of FIG. 4 and the response may be the response 4140 of FIG. 4. The LLM may be local to the vehicle, e.g., the LLM may be executed by a computing device of the vehicle, such as the computing device 3000 of FIG. 3. Alternatively or additionally, the LLM may be remote to the vehicle, e.g., the LLM may be executed by a computing device in a data center, such as the computing apparatus 2410 of the data-processing center 2400 of FIG. 2. The LLM may be pretrained on a general corpus of text data prior to fine-tuning on driving and parking incident data. Fine-tuning may comprise a specialized dataset of driving and parking incidents to enhance its understanding of vehicle-related contexts. In some implementations, the LLM is restricted from being fine-tuned on the embeddings stored and/or retrieved from the database. Such restriction may be beneficial, for example, to preserve an original or intentionally static knowledge base of the LLM.

The step 6090 comprises outputting the response as an answer to the question. The answer may be the answer 4150 of FIG. 4. Outputting the answer may be performed by an interface module, such as the interface 4020 of FIG. 4. The interface module may be local to the vehicle or it may be remote to the vehicle (or both). The answer may comprise a suitable format, such as text, audio, or video.

The above-described techniques can be implemented as a method, a system, and a non-transitory computer-readable medium, for example, as described below.

In an example implementation as a method, the method comprises: recording, by sensors of a vehicle, incidents of driving and parking based on predefined triggering conditions; filtering the incidents to identify relevant incidents for storage; generating embeddings corresponding to the relevant incidents; storing the embeddings in a database; receiving a question concerning the relevant incidents; retrieving from the database, using retrieval-augmented generation (RAG), one or more relevant embeddings based on the question; generating a prompt based on the question and contextual information associated with the one or more relevant embeddings; generating, by a large language model (LLM), a response to the prompt; and outputting the response as an answer to the question.

In some implementations, the sensors comprise at least one of: a lidar sensor; a radar sensor; a sonar sensor; an ultrasonic sensor; an infrared sensor; an optical camera; or a Global Navigation Satellite System (GNSS) sensor.

In some implementations, the method further comprises: filtering, by a filtering module of the vehicle, the incidents to identify the relevant incidents for storage.

In some implementations, the method further comprises: generating, by an embedding module of the vehicle, the embeddings corresponding to the relevant incidents.

In some implementations, the database is housed within the vehicle.

In some implementations, the method further comprises: retrieving, using RAG executed by a retrieval module of the vehicle, the one or more relevant embeddings.

In some implementations, the LLM is executed by a computing device of the vehicle.

In some implementations, the LLM is executed by a cloud server.

In some implementations, the triggering conditions comprise at least one of: activation of an engine of the vehicle; activation of a predefined drive mode of the vehicle; a number of occupants of the vehicle exceeding a predefined threshold; a charge state of a battery of the vehicle dropping below a predefined threshold; the vehicle exceeding a predefined speed threshold; the vehicle exceeding a predefined acceleration or deceleration threshold; the vehicle exceeding a predefined change of direction threshold; the vehicle coming within a predefined distance of an object; the vehicle entering or exiting a predefined geofenced area; or the vehicle receiving driver input to initiate recording.

In some implementations, the triggering conditions comprise at least one of: detection, by one of the sensors of the vehicle, of a predefined object near the vehicle; or detection, by one of the sensors of the vehicle, of a predefined vehicle near the vehicle.

In some implementations, the method further comprises: encrypting the embeddings prior to storage.

In some implementations, the method further comprises filtering the incidents to identify relevant incidents for storage based on at least one of: severity of the incidents; proximities of the incidents to predefined geographic locations; times of occurrence of the incidents; or presence of specific driving behaviors.

In some implementations, the method further comprises retrieving the relevant embeddings based on at least one of: similarity scores between the question and the embeddings; proximities of the embeddings to a predefined threshold; or occurrences of specific keywords or features within the embeddings that match the question.

In some implementations, the LLM is pretrained on a general corpus of text data prior to fine-tuning on driving and parking incident data.

In some implementations, the LLM is fine-tuned, after pretraining, on a specialized dataset of driving and parking incidents to enhance its understanding of vehicle-related contexts.

In some implementations, the method further comprises: restricting fine-tuning of the LLM by the embeddings.

In some implementations, the question comprises a voice command, the method further comprising: receiving the voice command by a voice recognition module coupled to the LLM.

In some implementations, the database comprises a vector database.

In another example implementation as a non-transitory computer-readable medium, the non-transitory computer-readable medium stores instructions operable to cause one or more processors to perform operations comprising: recording, by sensors of a vehicle, incidents of driving and parking based on predefined triggering conditions; filtering the incidents to identify relevant incidents for storage; generating embeddings corresponding to the relevant incidents; storing the embeddings in a database; receiving a question concerning the relevant incidents; retrieving from the database, using retrieval-augmented generation (RAG), one or more relevant embeddings based on the question; generating a prompt based on the question and contextual information associated with the one or more relevant embeddings; generating, by a large language model (LLM), a response to the prompt; and outputting the response as an answer to the question.

In another example implementation as a system, the system comprises one or more memories; and one or more processors configured to execute instructions stored in the one or more memories to: record, by sensors of a vehicle, incidents of driving and parking based on predefined triggering conditions; filter the incidents to identify relevant incidents for storage; generate embeddings corresponding to the relevant incidents; store the embeddings in a database; receive a question concerning the relevant incidents; retrieve, using retrieval-augmented generation (RAG), one or more relevant embeddings based on the question; generate a prompt based on the question and contextual information associated with the one or more relevant embeddings; generate, by a large language model (LLM), a response to the prompt; and output the response as an answer to the question.

As used herein, the terminology “example,” “embodiment,” “implementation,” "aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
recording, by sensors of a vehicle, incidents of driving and parking based on predefined triggering conditions;
filtering the incidents to identify relevant incidents for storage;
generating embeddings corresponding to the relevant incidents;
storing the embeddings in a database;
receiving a question concerning the relevant incidents;
retrieving from the database, using retrieval-augmented generation (RAG), one or more relevant embeddings based on the question;
generating a prompt based on the question and contextual information associated with the one or more relevant embeddings;
generating, by a large language model (LLM), a response to the prompt; and
outputting the response as an answer to the question.

2. The method of claim 1, wherein the sensors comprise at least one of:
a lidar sensor;
a radar sensor;
a sonar sensor;
an ultrasonic sensor;
an infrared sensor;
an optical camera; or
a Global Navigation Satellite System (GNSS) sensor.

3. The method of claim 1, further comprising:
filtering, by a filtering module of the vehicle, the incidents to identify the relevant incidents for storage.

4. The method of claim 1, further comprising:
generating, by an embedding module of the vehicle, the embeddings corresponding to the relevant incidents.

5. The method of claim 1, wherein:
the database is housed within the vehicle.

6. The method of claim 1, further comprising:
retrieving, using RAG executed by a retrieval module of the vehicle, the one or more relevant embeddings.

7. The method of claim 1, wherein:
the LLM is executed by a computing device of the vehicle.

8. The method of claim 1, wherein:
the LLM is executed by a cloud server.

9. The method of claim 1, wherein the triggering conditions comprise at least one of:
activation of an engine of the vehicle;
activation of a predefined drive mode of the vehicle;
a number of occupants of the vehicle exceeding a predefined threshold;
a charge state of a battery of the vehicle dropping below a predefined threshold;
the vehicle exceeding a predefined speed threshold;
the vehicle exceeding a predefined acceleration or deceleration threshold;
the vehicle exceeding a predefined change of direction threshold;
the vehicle coming within a predefined distance of an object;
the vehicle entering or exiting a predefined geofenced area; or
the vehicle receiving driver input to initiate recording.

10. The method of claim 1, wherein the triggering conditions comprise at least one of:
detection, by one of the sensors of the vehicle, of a predefined object near the vehicle; or
detection, by one of the sensors of the vehicle, of a predefined vehicle near the vehicle.

11. The method of claim 1, further comprising:
encrypting the embeddings prior to storage.

12. The method of claim 1, further comprising filtering the incidents to identify relevant incidents for storage based on at least one of:
severity of the incidents;
proximities of the incidents to predefined geographic locations;
times of occurrence of the incidents; or
presence of specific driving behaviors.

13. The method of claim 1, further comprising retrieving the one or more relevant embeddings based on at least one of:
similarity scores between the question and the embeddings;
proximities of the embeddings to a predefined threshold; or
occurrences of specific keywords or features within the embeddings that match the question.

14. The method of claim 1, wherein:
the LLM is pretrained on a general corpus of text data prior to fine-tuning on driving and parking incident data.

15. The method of claim 1, wherein:
the LLM is fine-tuned, after pretraining, on a specialized dataset of driving and parking incidents to enhance its understanding of vehicle-related contexts.

16. The method of claim 1, further comprising:
restricting fine-tuning of the LLM by the embeddings.

17. The method of claim 1, wherein the question comprises a voice command, the method further comprising:
receiving the voice command by a voice recognition module coupled to the LLM.

18. The method of claim 1, wherein:
the database comprises a vector database.

19. A non-transitory computer-readable medium storing instructions operable to cause one or more processors to perform operations comprising:
recording, by sensors of a vehicle, incidents of driving and parking based on predefined triggering conditions;
filtering the incidents to identify relevant incidents for storage;
generating embeddings corresponding to the relevant incidents;
storing the embeddings in a database;
receiving a question concerning the relevant incidents;
retrieving from the database, using retrieval-augmented generation (RAG), one or more relevant embeddings based on the question;
generating a prompt based on the question and contextual information associated with the one or more relevant embeddings;
generating, by a large language model (LLM), a response to the prompt; and
outputting the response as an answer to the question.

20. A system, comprising:
one or more memories; and
one or more processors configured to execute instructions stored in the one or more memories to:
record, by sensors of a vehicle, incidents of driving and parking based on predefined triggering conditions;
filter the incidents to identify relevant incidents for storage;
generate embeddings corresponding to the relevant incidents;
store the embeddings in a database;
receive a question concerning the relevant incidents;
retrieve from the database, using retrieval-augmented generation (RAG), one or more relevant embeddings based on the question;
generate a prompt based on the question and contextual information associated with the one or more relevant embeddings;
generate, by a large language model (LLM), a response to the prompt; and
output the response as an answer to the question.
